(19) United States
(12) Patent Application Publication
(10) Pub. No.: US 2016/0288045 A1
(43) Pub. Date: Oct. 6, 2016

(54) SCRUBBERS

(71) Applicant: BWA WATER ADDITIVES UK LIMITED, MANCHESTER (GB)

(72) Inventors: JEFFREY FRANK KRAMER, TUCKER, GA (US); THOMAS SCLAFANI, SOUDERTON, PA (US)

(21) Appl. No.: 14/673,419

(22) Filed: Mar. 30, 2015

(51) Int. Cl. B01D 53/14; B01D 53/52; C08F 220/58; C08F 120/06; C08F 220/06; B01D 53/78; B01D 53/44

(52) U.S. Cl. CPC B01D 53/1493; B01D 53/1487; B01D 53/1468; B01D 53/78; B01D 53/52; B01D 53/44; C08F 120/06; C08F 220/06; C08F 220/58; B01D 2252/20; C08F 2220/585

(57) ABSTRACT

The present invention relates to scrubbers, particularly though not exclusively to scrubbers for treating hydrogen sulfide and mercaptan containing air streams and to scrubber media for use therein. There are provided scrubber media comprising a polycarboxylic acid composition. Also provided are methods of treating a scrubber media by addition of a polycarboxylic acid composition as well as scrubber apparatus containing a scrubber media comprising a polycarboxylic acid composition. Also provided are methods of treating a gas stream by introducing a gas stream into a scrubber media which comprises a polycarboxylic acid composition and a polycarboxylic acid composition for use to extend the operating life of a scrubber media.

### FIELD OF INVENTION

The present invention relates to scrubbers, particularly though not exclusively to scrubbers for treating hydrogen sulfide and mercaptan containing air streams and to scrubber media for use therein.

### BACKGROUND TO INVENTION

It is known to use a scrubber to treat a gas stream to remove constituents from the gas stream. Scrubbers have various applications and one known application is to remove volatile compounds such as hydrogen sulfide and mercaptans from contaminated air streams to render the air stream acceptable for discharge to atmosphere.

A scrubber for removing hydrogen sulfide and mercaptans from a gas stream may comprise a scrubber unit such as a forced-induction scrubber and which contains a media into which a gas stream is introduced. In use, the gas stream passes through the media and hydrogen sulfide and mercaptans are removed from the gas stream following which the treated gas stream exits the scrubber unit.

Various scrubber media are known depending on their application and when used for removing hydrogen sulfide and mercaptans from a gas stream they are typically sodium hydroxide based.

In the scrubber process the hydrogen sulfide and mercaptans are captured by the scrubber media and over time the media becomes saturated and requires replacement. The time taken for a scrubber media to become saturated is dependent on a number of factors including the capacity of the scrubber and the levels of hydrogen sulfide and mercaptans of the gas stream fed to it, but periods of around 30 days are typical.

Whilst known scrubbers and scrubber media are effective there remains a need for improved scrubbers and scrubber media. Accordingly, the present invention aims to address at least one disadvantage associated with the prior art whether discussed herein or otherwise.

### SUMMARY OF INVENTION

According to a first aspect of the present invention there is provided a scrubber media comprising a polycarboxylic acid composition.

The scrubber media may comprise a polycarboxylic acid composition which comprises a single type of polycarboxylic acid and/or salts and/or ions thereof.

Suitably, the scrubber media comprises a polycarboxylic acid composition which comprises a combination of two or more types of polycarboxylic acid and/or salts and/or ions thereof.

Suitably, the polycarboxylic acid composition comprises one or more polycarboxylic acid homopolymers and/or copolymers. The polycarboxylic acid composition may consist of polycarboxylic acid homopolymers and/or copolymers.

Suitably, the scrubber media comprises an aqueous solution of one or more polycarboxylic acids. The polycarboxylic acid composition may consist of polycarboxylic acid homopolymers and/or copolymers and water.

Suitably, the polycarboxylic acid composition comprises polycarboxylic acids having a number average molecular weight of 20,000 or less, for example of 10,000 or less. Suitably, the polycarboxylic acid composition comprises polycarboxylic acids having a number average molecular weight of at least 500, for example at least 1000. Suitably, the polycarboxylic acid composition comprises polycarboxylic acids having a number average molecular weight of from 500 to 20,000, for example from 1000 to 10,000.

Suitably, the polycarboxylic acid composition comprises polycarboxylic acids having a weight average molecular weight of 20,000 or less, for example of 10,000 or less, Suitably, the polycarboxylic acid composition comprises polycarboxylic acids having a weight average molecular weight of at least 500, for example at least 1000. Suitably, the polycarboxylic acid composition comprises polycarboxylic acids having a weight average molecular weight of from 500 to 20,000, for example from 1000 to 10,000.

Suitably, the scrubber media comprises a polycarboxylic acid composition which comprises a polymer having at least one unit of formula (I):

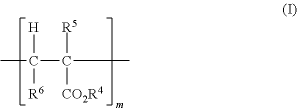

wherein:
R⁴ is selected from:
a hydrogen atom;
an alkali metal cation, an ammonium ion or an amine residue;
an alkyl group having from 1 to 4 carbon atoms; or
a phenyl group;
   R⁵ is selected from:
a hydrogen atom;
a methyl group or a group —CO₂R⁷ wherein R⁷ is an alkyl group comprising from 1 to 4 carbon atoms;
   and
   R⁶ is selected from:
a hydrogen atom;
an alkyl group comprising 1 to 4 carbon atoms optionally substituted by a hydroxyl group; or
a group —CO₂R⁸ wherein R⁸ is selected from a hydrogen atom or an alkyl group comprising from 1 to 4 carbon atoms;
   and m is an integer.

Suitably, R⁴ is selected from a hydrogen atom, an alkali metal cation, an ammonium ion or an amine residue. Suitably R⁴ is a hydrogen atom.

Suitably, R⁵ and R⁶ are each independently selected from a hydrogen atom or a methyl group. Suitably R⁵ and R⁶ are hydrogen atoms.

Suitably, m is an integer from 2 to 300, suitably from 2 to 200, suitably from 5 to 100.

Suitably R⁴ and R⁶ are hydrogen atoms and R⁵ is selected from a hydrogen atom or a methyl group.

The scrubber media may comprises a polycarboxylic acid composition which comprises a polymer having a homopolymer chain consisting of units of formula (I).

The scrubber media may comprise a polycarboxylic acid composition which comprises a copolymer.

Suitably, the scrubber media comprises a polycarboxylic acid composition which comprises a polymer having at least one unit of formula (I) and at least one unit of formula (II):

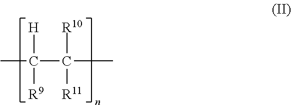

wherein:
R⁹ is selected from:
a hydrogen atom;
a methyl group; or
a group —CO₂R¹² wherein R¹² is selected from a hydrogen atom or an alkyl group comprising from 1 to 8 carbon atoms;
   R¹⁰ is selected from:
a hydrogen atom;
an alkyl group comprising from 1 to 4 carbon atoms;
a hydroxymethyl group; or
a group —CO₂R¹³ wherein R¹³ is selected from a hydrogen atom or an alkyl group comprising from 1 to 8 carbon atoms;
   R¹¹ is selected from:
a sulfonate containing group;
a residue —CO₂R¹⁴ wherein R¹⁴ is selected from a hydrogen atom or an alkyl group comprising from 1 to 4 carbon atoms;
a straight or branched alkyl residue having 1 to 8 carbon atoms optionally substituted by one to three carboxylic acid groups;
a phenyl residue;
an acetoxy residue;
hydroxymethyl;
an acetoxymethyl residue;
—SO₃M, —CH₂SO₃M, —PO₃M₂ or PO₃M′₂ in which M is selected from hydrogen, an alkali metal or an alkaline earth metal and each M′ is M or C₁-C₄ alkyl;
a residue —CONR¹⁵R¹⁶ wherein R¹⁵ and R¹⁶ are the same or different and each is selected from hydrogen, a straight or branched chain alkyl residue having 1 to 8 carbon atoms, hydroxymethyl or a residue —CH(OH)—CO₂M, —C(CH₃)₂CH₂SO₃M or —C(CH₃)₂CH₂PO₃M₂ in which M is selected from hydrogen, an alkali metal or alkaline earth metal; or
—N(R¹⁷)COCH₃ in which R¹⁷ is selected from hydrogen or C₁-C₄ straight or branched chain alkyl;
   and n is an integer.

Suitably, R⁹ and R¹⁰ are each independently selected from a hydrogen atom or a methyl group. Suitably R⁹ and R¹⁰ are hydrogen atoms.

Suitably, n is an integer from 2 to 300, suitably from 2 to 200, suitably from 5 to 100.

Suitably, R¹¹ is a residue —CONR¹⁵R¹⁶ wherein R¹⁵ and R¹⁶ are the same or different and each is selected from hydrogen, a straight or branched chain alkyl residue having 1 to 8 carbon atoms, hydroxymethyl or a residue —CH(OH)—CO₂M, —C(CH₃)₂CH₂SO₃M or —C(CH₃)₂CH₂PO₃M₂ in which M is selected from hydrogen, an alkali metal or alkaline earth metal.

Suitably, R¹¹ is a sulfonate containing group and is selected from:
a group —(CH₂)ₓSO₃M wherein M is selected from a hydrogen atom, an alkali metal or an alkaline earth metal, x is 0 or is an integer having a value of from 1 to 4;
a group having the formula —CONHC(CX₃)₂CH₂SO₃M wherein X is selected from a hydrogen atom or a methyl group and M is selected from a hydrogen atom, an alkali metal or an alkaline earth metal;
a phenyl sulfonic acid group —C₆H₄SO₃M in which M is selected from a hydrogen atom, an alkali metal or an alkaline earth metal; or
a group having the formula —CH₂O—[CY₂]_{z}SO₃M wherein Y is selected from a hydrogen atom, a hydroxyl group or a methyl group, z is an integer having a value of from 1 to 4 and M is selected from a hydrogen atom, an alkali metal or an alkaline earth metal.

Suitably, R¹¹ is —C(CH₃)₂CH₂SO₃M in which M is selected from hydrogen, an alkali metal or alkaline earth metal.

Suitably, R¹¹ is —C(CH₃)₂CH₂SO₃M in which M is selected from hydrogen, an alkali metal or alkaline earth metal and R⁹ and R¹⁰ are hydrogen atoms.

Suitably, the scrubber media comprises a polycarboxylic acid composition which comprises a copolymer having at least one unit of formula (I) and at least one unit of formula (II).

Suitably, the scrubber media comprises a polycarboxylic acid composition which comprises a combination of: (i) a polymer having units of formula (I); and (ii) a copolymer having units of formula (I) and (II). Suitably, said polymers are water soluble. Suitably, said polymers have a molecular weight such that they are water soluble.

Suitably, the polycarboxylic acid composition comprises a polymer having units of formula (I) and which comprises a chain transfer agent. Suitably, the polycarboxylic acid composition comprises a polymer having units of formula (I) and units of formula (II) and which comprises a chain transfer agent.

Suitably, the polycarboxylic acid composition comprises a polycarboxylic acid homopolymer. The polycarboxylic acid composition may comprise an acrylic acid homopolymer. Suitably, the polycarboxylic acid composition comprises a polycarboxylic acid copolymer. Suitably, the polycarboxylic acid composition comprises a copolymer of carboxylic acid and sulfonic acid. Suitably, the polycarboxylic acid composition comprises a copolymer of acrylic acid and 2-acrylamido-2-methylpropane sulfonic acid (AMPS).

Suitably, the polycarboxylic acid composition comprises a phosphorus containing polymer.

Suitably, the polycarboxylic acid composition comprises a combination of two or more phosphorus containing polymers.

Suitably, according to the present invention there is provided a scrubber media comprising a polymer having formula (III):

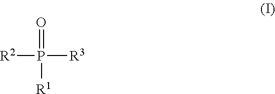

wherein:

R¹ is a residue —OX wherein X is selected from a hydrogen atom, an alkali metal or alkaline earth metal cation, an ammonium ion or an amine residue;

R² is a polymeric residue comprising at least one unit of formula (I):

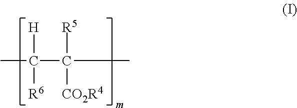

and optionally at least one unit of formula (II):

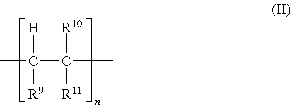

wherein R⁴, R⁵, R⁶, R⁹, R¹⁰ and R¹¹ in formula (I) and (II) are as defined above; and wherein:
R³ is selected from:
a residue —OX wherein X is selected from a hydrogen atom, an alkali metal or alkaline earth metal cation, an ammonium ion or an amine residue;
a hydrogen atom; or
a polymeric residue comprising at least one unit of formula (I) and optionally at least one unit of formula (II) and wherein formula (I) and formula (II) are as defined in relation to R² and wherein m and n are integers and the values of m and n in R³ are the same or different from the values of m and n in R².

Suitably, in R² m is an integer having a value of from 1 to 300, suitably 1 to 200, suitably 5 to 100. Suitably, in R² n is an integer having a value of from 1 to 300, suitably 1 to 200, suitably 5 to 100. Suitably, in R² n and m are integers and the sum of n+m is an integer having a value of from 3 to 300, suitably 3 to 200, suitably 5 to 100. Suitably, in R² the ratio of n:m, where n is present, is in the range 99:1 to 1:99.

Suitably, in R³ m is an integer having a value of from 1 to 300, suitably 1 to 200, suitably 5 to 100. Suitably, in R³ n is an integer having a value of from 1 to 300, suitably 1 to 200, suitably 5 to 100. Suitably, in R³ n and m are integers and the sum of n+m is an integer having a value of from 3 to 300, suitably 3 to 200, suitably 5 to 100. Suitably, in R³ the ratio of n:m, where n is present, is in the range 99:1 to 1:99.

Suitably, the polycarboxylic acid composition comprises a polymer which may conveniently be produced by the reaction of m moles of a compound having the formula (IV), wherein R⁴ is preferably a hydrogen atom:

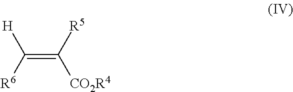

optionally with n moles of a compound having the formula (V):

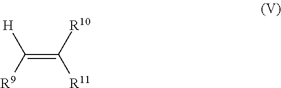

wherein R⁴, R⁵, R⁶, R⁹, R¹⁰ and R¹¹, n and m are as defined above,
suitably, with a chain transfer agent.

The chain transfer agent may for example be selected from: a phosphorous species, for example phosphorous acid and its salts, hypophosphorous acid and its salts; mercaptans; ferric salts; cupric salts; bisulfites; and lower alcohols, for example isopropanol.

Suitably, the polycarboxylic acid composition comprises a polymer which may conveniently be produced by the reaction of m moles of a compound having the formula (IV) optionally with n moles of a compound having the formula (V) and suitably with one molar proportion of hypophosphorous acid or a hypophosphite.

The scrubber media suitably comprises a polycarboxylic acid composition which comprises a homopolymeric phosphinopoly(meth) acrylic acid having the formula (VI):

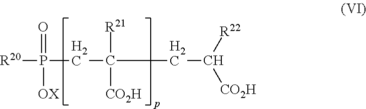

wherein X is selected from a hydrogen atom or an alkali metal cation, R²¹ is selected from a hydrogen atom or a methyl group, R²² is selected from a hydrogen atom or a methyl group and R²⁰ is selected from a hydrogen atom or a group of formula (VII):

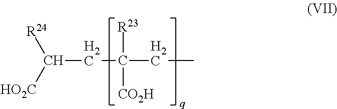

wherein R²³ is selected from a hydrogen atom or a methyl group, R²⁴ is selected from a hydrogen atom or a methyl group;
and wherein p and q are integers.

The scrubber media suitably comprises a polycarboxylic acid composition which comprises a copolymeric phosphinopolycarboxylic acid (A) having the formula (III) wherein in the unit of formula (II) R¹¹ is selected from:
a group —(CH₂)ₓSO₃M wherein M is selected from a hydrogen atom, an alkali metal cation or an alkaline earth metal cation, x is 0 or an integer having a value of from 1 to 4;
a group having the formula —CONHC(CX₃)₂CH₂SO₃M wherein X is selected from a hydrogen atom or a methyl group and wherein M is selected from a hydrogen atom, an alkali metal cation or an alkaline earth metal cation;
a phenyl sulfonic acid group —C₆H₄SO₃M and wherein M is selected from a hydrogen atom, an alkali metal cation or an alkaline earth metal cation; or
a group having the formula CH₂—O—[CY₂]_{z}SO₃M wherein Y is selected from a hydrogen atom a hydroxyl group or a methyl group and z is an integer having a value of from 1 to 4 and wherein M is selected from a hydrogen atom, an alkali metal cation or an alkaline earth metal cation.

Suitably, in the copolymeric phosphinopolycarboxylic acid (A) in the unit of formula (II) R¹¹ comprises a group having the formula —CONHC(CX₃)₂CH₂SO₃M wherein X is selected from a hydrogen atom or a methyl group and wherein M is selected from a hydrogen atom, an alkali metal cation or an alkaline earth metal cation.

Suitably, in the copolymeric phosphinopolycarboxylic acid (A) in the unit of formula (II) R¹¹ comprises a group having the formula —CONHC(CH₃)₂CH₂SO₃M wherein M is selected from a hydrogen atom, an alkali metal cation or an alkaline earth metal cation. Suitably, M is a hydrogen atom.

Suitably, in the copolymeric phosphinopolycarboxylic acid (A) in the unit of formula (II) R⁹ and R¹⁰ are hydrogen atoms.

Suitably, in the copolymeric phosphinopolycarboxylic acid (A) in the unit of formula (I) R⁵ and R⁶ are each independently selected from a hydrogen atom or a methyl group. Suitably R⁵ and R⁶ are hydrogen atoms.

Suitably, in the copolymeric phosphinopolycarboxylic acid (A) in the unit of formula (I) R⁴ is selected from a hydrogen atom or an alkali metal cation, an ammonium ion or an amine residue. Suitably R⁴ is a hydrogen atom.

Suitably, the scrubber media comprises a polycarboxylic acid composition which comprises a combination of a homopolymeric phosphinopoly(meth) acrylic acid having the formula (VI) as defined above and a polymer which is a copolymeric phosphinopolycarboxylic acid (A) as defined above.

The scrubber media may comprise a polycarboxylic acid composition comprising a polymer according to formula (III) in which some or all of the acidic hydrogens in the polymer have been replaced by cations derived from salt forming bases of alkali metals or alkaline earth metals.

Suitably, the scrubber media comprises polycarboxylic acid composition comprising one or more phosphino polycarboxylic acids or salts thereof. Suitably, the scrubber media comprises two or more phosphino polycarboxylic acids or salts thereof.

The scrubber media may comprise one or more phosphono polycarboxylic acids or salts thereof. The scrubber media may comprise two or more phosphono polycarboxylic acids or salts thereof.

Suitably, the scrubber media comprises a phosphino polycarboxylic acid. Suitably, the scrubber media comprises two or more phosphino polycarboxylic acids.

Suitably, the scrubber media comprises a phosphino polycarboxylic acid homopolymer. Suitably, the scrubber media comprises a phosphino polycarboxylic acid copolymer.

The scrubber media may comprise a phosphono polycarboxylic acid. The scrubber media may comprise two or more phosphono polycarboxylic acids.

The scrubber media may comprise a phosphono polycarboxylic acid homopolymer. The scrubber media may comprise a phosphono polycarboxylic acid copolymer.

Suitably, the scrubber media comprises a phosphinopolycarboxylic acid or salt thereof, a phosphonopolycarboxylic acid or salt thereof, a phosphino carboxylic acid and sulfonic acid copolymer or salt thereof and/or a phosphono carboxylic acid and sulfonic acid copolymer or salt thereof.

Suitably, the scrubber media comprises a combination of two or more of: a phosphinopolycarboxylic acid or salt thereof, a phosphonopolycarboxylic acid or salt thereof, a phosphino carboxylic acid and sulfonic acid copolymer or salt thereof and/or a phosphono carboxylic acid and sulfonic acid copolymer or salt thereof.

Suitably, the scrubber media comprises (i) a phosphinopolycarboxylic acid or salt thereof and/or a phosphonopolycarboxylic acid or salt thereof in combination with (ii) a phosphino carboxylic acid and sulfonic acid copolymer or salt thereof and/or a phosphono carboxylic acid and sulfonic acid copolymer or salt thereof.

Suitably, the scrubber media comprises a polycarboxylic acid composition comprising polymer P1 having formula (III-P1)

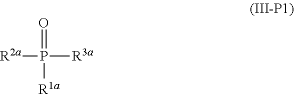

wherein:
R^{1a} is an —OX residue wherein X is selected from hydrogen or an alkali metal cation;
R^{2a} is a copolymer of acrylic acid and 2-acrylamido-2-methylpropane sulfonic acid (AMPS); and
R^{3a} is a copolymer of acrylic acid and 2-acrylamido-2-methylpropane sulfonic acid (AMPS) or
R^{3a} is an —OX residue wherein X is selected from hydrogen or an alkali metal cation.

Suitably, in formula (III-P1) R^{3a} is a copolymer of acrylic acid and 2-acrylamido-2-methylpropane sulfonic acid (AMPS).

Suitably, R^{2a} is a copolymer of (a) acrylic acid and (b) 2-acrylamido-2-methylpropane sulfonic acid (AMPS) and comprises (a) and (b) in a molar ratio of from 1:20 to 20:1. Suitably, R^{2a} is a copolymer of (a) acrylic acid and (b) 2-acrylamido-2-methylpropane sulfonic acid (AMPS) and comprises (a) and (b) in a molar ratio of from 1:9 to 9:1, suitably from 1:2 to 2:1, for example 1:1.

Suitably, R^{2a} is a copolymer of (a) acrylic acid and (b) 2-acrylamido-2-methylpropane sulfonic acid (AMPS) and comprises (a) and (b) in a molar ratio of (a):(b) of at least 1:20, for example at least: 1:19; 1:18; 1:17; 1:16; 1:15; 1:14; 1:13; 1:12; 1:11 or 1:10. Suitably, R^{2a} is a copolymer of (a) acrylic acid and (b) 2-acrylamido-2-methylpropane sulfonic acid (AMPS) and comprises (a) and (b) in a molar ratio of (a):(b) of at least 1:9, for example at least: 1:8; 1:7; 1:6; 1:5; 1:4; 1:3; 1:2 or 1:1.

Suitably, R^{2a} is a copolymer of (a) acrylic acid and (b) 2-acrylamido-2-methylpropane sulfonic acid (AMPS) and comprises (a) and (b) in a molar ratio of (a):(b) of no more than 20:1 for example no more than: 19:1; 18:1; 17:1; 16:1; 15:1; 14:1; 13:1; 12:1; 11:1 or 10:1. Suitably, R^{2a} is a copolymer of (a) acrylic acid and (b) 2-acrylamido-2-methylpropane sulfonic acid (AMPS) and comprises (a) and (b) in a molar ratio of (a):(b) of no more than 9:1, for example no more than: 8:1; 7:1; 6:1; 5:1; 4:1; 3:1; 2:1 or 1:1.

Suitably, where R^{3a} is a copolymer of (a) acrylic acid and (b) 2-acrylamido-2-methylpropane sulfonic acid (AMPS) then R^{3a} comprises (a) and (b) in a molar ratio of from 1:20 to 20:1. Suitably, where R³ is a copolymer of (a) acrylic acid and (b) 2-acrylamido-2-methylpropane sulfonic acid (AMPS) then R^{3a} comprises (a) and (b) in a molar ratio of from 1:9 to 9:1, suitably from 1:2 to 2:1, for example 1:1.

Suitably, where R^{3a} is a copolymer of (a) acrylic acid and (b) 2-acrylamido-2-methylpropane sulfonic acid (AMPS) then R^{3a} comprises (a) and (b) in a molar ratio of (a):(b) of at least 1:20, for example at least: 1:19; 1:18; 1:17; 1:16; 1:15; 1:14; 1:13; 1:12; 1:11 or 1:10. Suitably, where R^{3a} is a copolymer of (a) acrylic acid and (b) 2-acrylamido-2-methylpropane sulfonic acid (AMPS) then R^{3a} comprises (a) and (b) in a molar ratio of (a):(b) of at least 1:9, for example at least: 1:8; 1:7; 1:6; 1:5; 1:4; 1:3; 1:2 or 1:1.

Suitably, where R^{3a} is a copolymer of (a) acrylic acid and (b) 2-acrylamido-2-methylpropane sulfonic acid (AMPS) then R³ comprises (a) and (b) in a molar ratio of (a):(b) of no more than 20:1 for example no more than: 19:1; 18:1; 17:1; 16:1; 15:1; 14:1; 13:1; 12:1; 11:1 or 10:1. Suitably, where R^{3a} is a copolymer of (a) acrylic acid and (b) 2-acrylamido-2-methylpropane sulfonic acid (AMPS) then R³ comprises (a) and (b) in a molar ratio of (a):(b) of no more than 9:1, for example no more than: 8:1; 7:1; 6:1; 5:1; 4:1; 3:1; 2:1 or 1:1.

Suitably, the scrubber media comprises a polycarboxylic acid composition comprising polymer P2 having formula (III-P2)

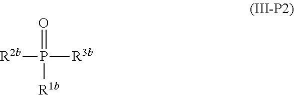

wherein
R^{1b} is an —OX residue wherein X is selected from hydrogen or an alkali metal cation;
R^{2b} is a homopolymer of acrylic acid or methacrylic acid; and
R^{3b} is a homopolymer of acrylic acid or methacrylic acid or R^{3b} is an —OX residue wherein X is selected from hydrogen or an alkali metal cation.

Suitably, in formula (III-P2) R^{2b} is a homopolymer of acrylic acid; and R^{3b} is a homopolymer of acrylic acid.

Suitably, in formula (III-P2) R^{2b} is a homopolymer of methacrylic acid; and R^{3b} is a homopolymer of methacrylic acid.

Suitably, the scrubber media comprises a polycarboxylic acid composition which comprises a polymer combination. Suitably, the scrubber media comprises a polycarboxylic acid composition which comprises a water soluble polymer combination.

The scrubber media may comprise partially neutralised polycarboxylic acids.

Suitably, the scrubber media comprises a polycarboxylic acid composition which is neutralised to between pH 8 and pH 9 prior to combination with other constituents of the scrubber media. Suitably, the scrubber media comprises a polycarboxylic acid composition wherein the pH of the polycarboxylic acid composition is adjusted to between pH 8.0 and pH 9.0 prior to combination with other constituents of the scrubber media.

Suitably, the scrubber media comprises a combination of a polymer P1 and a polymer P2.

Suitably, the scrubber media comprises a combination of polymer P1 and polymer P2 wherein the weight ratio of P1 to P2 in the scrubber media is from 1:9 to 9:1, suitably from 1:2 to 2:1, for example 1:1.

Suitably, the weight ratio of P1 to P2 in the scrubber media is at least 1:9, for example at least: 1:8; 1:7; 1:6; 1:5; 1:4; 1:3; 1:2 or 1:1.

Suitably, the weight ratio of P1 to P2 in the scrubber media is no more than 9:1, for example no more than: 8:1; 7:1; 6:1; 5:1; 4:1; 3:1; 2:1 or 1:1.

Suitably, the scrubber media comprises a combination of a phosphino homopolymer of acrylic acid and a phosphino copolymer of acrylic acid and 2-acrylamido-2-methylpropane sulfonic acid (AMPS).

Suitably, the scrubber media comprises a combination of (i) a phosphino homopolymer of acrylic acid and (ii) a phosphino copolymer of acrylic acid and 2-acrylamido-2-methylpropane sulfonic acid (AMPS) wherein the weight ratio of (i) to (ii) in the scrubber media is from 1:9 to 9:1, suitably from 1:2 to 2:1, for example 1:1.

Suitably, the scrubber media comprises a combination of (i) a phosphino homopolymer of acrylic acid and (ii) a phosphino copolymer of acrylic acid and 2-acrylamido-2-methylpropane sulfonic acid (AMPS) wherein weight ratio of (i):(ii) in the scrubber media is at least 1:9, for example at least: 1:8; 1:7; 1:6; 1:5; 1:4; 1:3; 1:2 or 1:1.

Suitably, the scrubber media comprises a combination of (i) a phosphino homopolymer of acrylic acid and (ii) a phosphino copolymer of acrylic acid and 2-acrylamido-2-methylpropane sulfonic acid (AMPS) wherein weight ratio of (i):(ii) in the scrubber media is no more than 9:1, for example no more than: 8:1; 7:1; 6:1; 5:1; 4:1; 3:1; 2:1 or 1:1.

Suitably, the scrubber media comprises a polycarboxylic acid, suitably a phosphorus containing polycarboxylic acid, in an amount of at least 10 ppm by weight, suitably at least 50 ppm by weight, for example at least 100 ppm by weight.

As used herein, ppm refers to parts per million.

Suitably, the scrubber media comprises polycarboxylic acid in an amount of at least 200 ppm by weight, for example at least: 300 ppm; 400 ppm; 500 ppm; 600 ppm; 700 ppm; 800 ppm; 900 ppm; 1000 ppm; 1100 pm 1200 ppm; 1300 ppm; 1400 ppm; 1500 ppm; 1600 ppm; 1700 ppm; 1800 ppm; 1900 ppm or 2000 ppm by weight.

Suitably, the scrubber media comprises polycarboxylic acid in an amount of no more than 5000 ppm; suitably no more than 4000 ppm, for example no more than 3000 ppm.

Suitably, the scrubber media comprises polycarboxylic acid in an amount of between 1000 ppm and 3000 ppm by weight, for example between 1500 ppm and 2500 ppm by weight.

Suitably, the scrubber media comprises a combination of polymer P1 and polymer P2 in an amount of at least 10 ppm by weight, suitably at least 50 ppm by weight, for example at least 100 ppm by weight.

Suitably, the scrubber media comprises a combination of polymer P1 and polymer P2 in an amount of at least 200 ppm by weight, for example at least: 300 ppm; 400 ppm; 500 ppm; 600 ppm; 700 ppm; 800 ppm; 900 ppm; 1000 ppm; 1100 pm; 1200 ppm; 1300 ppm; 1400 ppm; 1500 ppm; 1600 ppm; 1700 ppm; 1800 ppm; 1900 ppm or 2000 ppm by weight.

Suitably, the scrubber media comprises a combination of polymer P1 and polymer P2 in an amount of no more than 5000 ppm; suitably no more than 4000 ppm, for example no more than 3000 ppm.

Suitably, the scrubber media comprises a combination of polymer P1 and polymer P2 in an amount of between 1000 ppm and 3000 ppm by weight, for example between 1500 ppm and 2500 ppm by weight.

Suitably, the scrubber media comprises a combination of (i) a phosphino homopolymer of acrylic acid and (ii) a phosphino copolymer of acrylic acid and 2-acrylamido-2-methylpropane sulfonic acid (AMPS) in a combined amount of at least 10 ppm by weight, suitably at least 50 ppm by weight, for example at least 100 ppm by weight.

Suitably, the scrubber media comprises a combination of (i) a phosphino homopolymer of acrylic acid and (ii) a phosphino copolymer of acrylic acid and 2-acrylamido-2-methylpropane sulfonic acid (AMPS) in a combined amount of at least 200 ppm by weight, for example at least: 300 ppm; 400 ppm; 500 ppm; 600 ppm; 700 ppm; 800 ppm; 900 ppm; 1000 ppm; 1100 pm 1200 ppm; 1300 ppm; 1400 ppm; 1500 ppm; 1600 ppm; 1700 ppm; 1800 ppm; 1900 ppm or 2000 ppm by weight.

Suitably, the scrubber media comprises a combination of (i) a phosphino homopolymer of acrylic acid and (ii) a phosphino copolymer of acrylic acid and 2-acrylamido-2-methylpropane sulfonic acid (AMPS) in a combined amount of no more than 5000 ppm; suitably no more than 4000 ppm, for example no more than 3000 ppm.

Suitably, the scrubber media comprises a combination of (i) a phosphino homopolymer of acrylic acid and (ii) a phosphino copolymer of acrylic acid and 2-acrylamido-2-methylpropane sulfonic acid (AMPS) in a combined amount of between 1000 ppm and 3000 ppm by weight, for example between 1500 ppm and 2500 ppm by weight.

The scrubber media may be adapted to treat a gas stream from a storage tank, for example a tar oil storage tank. The scrubber media may be adapted to treat an air stream, for example an air stream comprising hydrogen sulfide contaminant.

Suitably, the scrubber media is adapted to treat a gas stream comprising hydrogen sulfide. Suitably, the scrubber media is adapted to treat a gas stream comprising mercaptans. Suitably, the scrubber media is adapted to treat a gas stream comprising C₁-C₆ mercaptans. Suitably, the scrubber media is adapted to treat a gas stream comprising VOCs. Suitably, the scrubber media is adapted to treat a gas stream comprising C₅-C₈ VOCs. Suitably, the scrubber media is adapted to treat a gas stream comprising hydrogen sulfide and mercaptans.

Suitably, the scrubber media is adapted to capture hydrogen sulfide. Suitably, the scrubber media is adapted to capture mercaptans. Suitably, the scrubber media is adapted to capture C₁-C₆ mercaptans. The scrubber media may be adapted to capture VOCs. Suitably, the scrubber media is adapted to capture hydrogen sulfide and mercaptans.

Suitably, the scrubber media comprises a caustic media. Suitably, the scrubber media comprises a caustic compound. Suitably, the scrubber media comprises sodium hydroxide.

Suitably, the scrubber media comprises a caustic compound adapted to capture hydrogen sulfide from a gas stream. Suitably, the scrubber media comprises a caustic compound adapted to capture mercaptans from a gas stream. The scrubber media may comprise a caustic compound adapted to capture VOCs from a gas stream. Suitably, the scrubber media comprises a caustic compound adapted to capture hydrogen sulfide and mercaptans from a gas stream.

Suitably, the scrubber media comprises a scavenger additive.

Suitably, the scrubber media comprises a scavenger additive adapted to capture hydrogen sulfide from a gas stream. Suitably, the scrubber media comprises a scavenger additive adapted to capture mercaptans from a gas stream. The scrubber media may comprise a scavenger additive adapted to capture VOCs from a gas stream. Suitably, the scrubber media comprises a scavenger additive adapted to capture hydrogen sulfide and mercaptans from a gas stream.

Suitably, the scrubber media comprises a scavenger additive which comprises sodium hydroxide.

Suitably, the scrubber media comprises a scavenger additive, suitably sodium hydroxide, in an amount of at least 10% by weight.

Suitably, the scrubber media comprises a scavenger additive, suitably sodium hydroxide, in an amount of at least 15% by weight; for example at least 20%; 25%; 30%; 35%; 40%; 45% or 50% by weight.

Suitably, the scrubber media comprises a scavenger additive, suitably sodium hydroxide, in an amount of no greater than 80% by weight.

Suitably, the scrubber media comprises a scavenger additive, suitably sodium hydroxide, in an amount of no greater than 75% by weight, for example no more than: 70%; 65%; 60%; 55% or 50% by weight.

Suitably, the scrubber media comprises a scavenger additive, suitably sodium hydroxide, in an amount of between 30% and 70% by weight, for example between 40% and 60% by weight.

The scrubber media may comprise an amine. The scrubber media may comprise a complex amine.

Suitably, the scrubber media comprises a polycarboxylic acid composition for use to increase the time interval before the scrubber media needs to be replaced in comparison to scrubber media absent said polycarboxylic acid composition. Suitably, the scrubber media is adapted to increase the time interval before replacement is required. Suitably, said replacement interval may be at least 20% longer than required for scrubber media absent a polycarboxylic acid composition. Suitably, said replacement window may be 50% longer, for example: 100%; 150%; or 200% longer. Suitably, the scrubber media is adapted to provide a threefold increase in the time interval before replacement is required in comparison to scrubber media absent polycarboxylic acid composition.

Surprisingly, it has been found that the inclusion of a polycarboxylic acid composition in a scrubber media may prolong the effective life of the scrubber media in comparison to a scrubber media absent the polycarboxylic acid composition.

Suitably, the scrubber media is adapted to last for in excess of 30 days in use in a scrubber before it requires replacement. Suitably, the scrubber media is adapted to last for in excess of 60 days in use in a scrubber before it requires replacement. Suitably, the scrubber media is adapted to last for in excess of 90 days in use in a scrubber before it requires replacement. Suitably, the scrubber media is adapted to last for 100 days or more in use in a scrubber before it requires replacement.

Suitably, the scrubber media comprises a polycarboxylic acid composition for use to increase the amount of hydrogen sulfide and/or mercaptans which can be captured by a given volume of scrubber media before said media becomes saturated in comparison to an equal volume of scrubber media absent said polycarboxylic acid composition. Suitably, the scrubber media is adapted to capture an increased amount of hydrogen sulfide and/or mercaptans.

Suitably, the scrubber media comprises a polycarboxylic acid composition for use to increase the volume of gas having a given concentration of hydrogen sulfide and/or mercaptans which can be passed through a given volume of scrubber media before said media becomes saturated in comparison to an equal volume of scrubber media absent said polycarboxylic acid composition. Suitably, the scrubber media is adapted to treat an increased volume of gas having a given concentration of hydrogen sulfide and/or mercaptans before said media becomes saturated.

Suitably, the scrubber media comprises a polycarboxylic acid composition for use to reduce the formation of back pressure in a scrubber in comparison to a scrubber media absent said polycarboxylic acid composition. Suitably, the scrubber media is adapted to reduce the formation of back pressure in a scrubber.

Suitably, the scrubber media comprises a polycarboxylic acid composition for use to inhibit the formation of scale in a scrubber. Suitably, the scrubber media is adapted to inhibit the formation of scale in a scrubber.

Suitably, the scrubber media comprises a polycarboxylic acid composition for use to reduce the rate of formation of salt deposits in a scrubber in comparison to a scrubber media absent said polycarboxylic acid composition. Suitably, the scrubber media is adapted to reduce the rate of formation of salt deposits in a scrubber.

Suitably, the scrubber media comprises a polycarboxylic acid composition for use to inhibit the formation of salt deposits in a scrubber. Suitably, the scrubber media is adapted to inhibit the formation of salt deposits in a scrubber.

Suitably, the scrubber media comprises a polycarboxylic acid composition for use to reduce the rate of formation of sodium carbonate deposits in a scrubber in comparison to a scrubber media absent said polycarboxylic acid composition. Suitably, the scrubber media is adapted to reduce the rate of formation of sodium carbonate deposits in a scrubber.

Suitably, the scrubber media comprises a polycarboxylic acid composition for use to inhibit the formation of sodium carbonate deposits in a scrubber. Suitably, the scrubber media is adapted to inhibit the formation of sodium carbonate deposits in a scrubber.

Suitably, the scrubber media comprises a polycarboxylic acid composition for use to alleviate the need to clean out the scrubber unit. Suitably, the scrubber media is adapted to alleviate the need to clean out the scrubber unit.

Suitably, the scrubber media comprises sodium hydroxide and a polycarboxylic acid composition. Suitably, the scrubber media comprises sodium hydroxide and one or more polycarboxylic acids or salts or ions thereof. Suitably, the scrubber media comprises sodium hydroxide and a combination of polycarboxylic acids or salts or ions thereof. Suitably, the scrubber media comprises sodium hydroxide and a combination of phosphine and/or phosphono polycarboxylic acids or salts thereof. Suitably, the scrubber media comprises sodium hydroxide and a combination of phosphino polycarboxylic acids or salts thereof. Suitably, the scrubber media comprises sodium hydroxide and a combination of phosphono polycarboxylic acids or salts thereof. Suitably, the scrubber media comprises sodium hydroxide and polymers P1 and P2. Suitably, the scrubber media comprises sodium hydroxide and a combination of (i) a phosphino homopolymer of acrylic acid and (ii) a phosphino copolymer of acrylic acid and 2-acrylamido-2-methylpropane sulfonic acid (AMPS).

Suitably, the scrubber media comprises an aqueous media. Suitably, the scrubber media comprises water in an amount of at least 20% by weight.

Suitably, the scrubber media comprises water in an amount of at least 25% by weight; for example, at least: 30%; 35%; 40%; 45% or 50% by weight.

Suitably, the scrubber media comprises water in an amount of no more than 90% by weight.

Suitably, the scrubber media comprises water in an amount of no more than 85% by weight, for example no more than: 80%; 75%; 70%; 65%; 60% or 65% by weight.

Suitably, the scrubber media comprises water in an amount of between 20% and 80% by weight, for example between 40% and 60% by weight.

Suitably, the scrubber media comprises water, sodium hydroxide and a polycarboxylic acid composition. Suitably, the scrubber media comprises water, sodium hydroxide and one or more polycarboxylic acids or salts or ions thereof. Suitably, the scrubber media comprises water, sodium hydroxide and a combination of polycarboxylic acids or salts or ions thereof. Suitably, the scrubber media comprises water, sodium hydroxide and a combination of phosphino and/or phosphono polycarboxylic acids or salts thereof. Suitably, the scrubber media comprises water, sodium hydroxide and a combination of phosphino polycarboxylic acids or salts thereof. Suitably, the scrubber media comprises water, sodium hydroxide and a combination of phosphono polycarboxylic acids or salts thereof. Suitably, the scrubber media comprises water, sodium hydroxide and polymers P1 and P2. Suitably, the scrubber media comprises water, sodium hydroxide and a combination of (i) a phosphino homopolymer of acrylic acid and (ii) a phosphino copolymer of acrylic acid and 2-acrylamido-2-methylpropane sulfonic acid (AMPS).

The scrubber media may consist of water, sodium hydroxide and a polycarboxylic acid composition. Suitably, the scrubber media consists of water, sodium hydroxide and one or more polycarboxylic acids or salts or ions thereof. The scrubber media may consist of water, sodium hydroxide and a combination of polycarboxylic acids or salts or ions thereof. The scrubber media may consist of water, sodium hydroxide and a combination of phosphino polycarboxylic acids or salts thereof. The scrubber media may consist of water, sodium hydroxide and polymers P1 and P2. The scrubber media may consist of water, sodium hydroxide and a combination of (i) a phosphino homopolymer of acrylic acid and (ii) a phosphino copolymer of acrylic acid and 2-acrylamido-2-methylpropane sulfonic acid (AMPS).

According to a second aspect of the present invention there is provided a method of treating a scrubber media by addition of a polycarboxylic acid composition to said scrubber media.

Suitably, the method comprises treating a scrubber media to prolong the operational life of the scrubber media by addition of a polycarboxylic acid composition to said scrubber media.

Suitably, the method comprises providing a treated scrubber media which comprises a polycarboxylic acid composition and which treated scrubber media comprises a scrubber media according to the first aspect.

The method may comprise treating a scrubber media by addition of a polycarboxylic acid composition which comprises a single type of polycarboxylic acid and/or salts and/or ions thereof.

Suitably, the method comprises treating a scrubber media by addition of a polycarboxylic acid composition which comprises a combination of two or more types of polycarboxylic acid and/or salts and/or ions thereof.

Suitably, the polycarboxylic acid composition comprises one or more polycarboxylic acid homopolymers and/or copolymers. The polycarboxylic acid composition may consist of polycarboxylic acid homopolymers and/or copolymers.

Suitably, the method comprises treating a scrubber media by addition of a polycarboxylic acid composition which comprises an aqueous solution of one or more polycarboxylic acids. The polycarboxylic acid composition may consist of polycarboxylic acid homopolymers and/or copolymers and water.

Suitably, the polycarboxylic acid composition comprises polycarboxylic acids having a number average molecular weight of 100,000 or less, suitably of 50,000 of less, for example of 30,000 or less, for example of 20,000 or less, for example of 10,000 or less. Suitably, the polycarboxylic acid composition comprises polycarboxylic acids having a number average molecular weight of at least 500, for example at least 1000. Suitably, the polycarboxylic acid composition comprises polycarboxylic acids having a number average molecular weight of from 500 to 20,000, for example from 1000 to 10,000,

Suitably, the polycarboxylic acid composition comprises polycarboxylic acids having a weight average molecular weight of 100,000 or less, suitably of 50,000 of less, for example of 30,000 or less, for example of 20,000 or less, for example of 10,000 or less, Suitably, the polycarboxylic acid composition comprises polycarboxylic acids having a weight average molecular weight of at least 500, for example at least 1000. Suitably, the polycarboxylic acid composition comprises polycarboxylic acids having a weight average molecular weight of from 500 to 20,000, for example from 1000 to 10,000,

Suitably, the method comprises treating a scrubber media by addition of a polycarboxylic acid composition which comprises a polymer having at least one unit of formula (I):

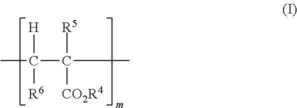

wherein:
R⁴ is selected from:
a hydrogen atom;
an alkali metal cation, an ammonium ion or an amine residue;
an alkyl group having from 1 to 4 carbon atoms; or
a phenyl group;
   R⁵ is selected from:
a hydrogen atom;
a methyl group or a group —CO₂R⁷ wherein R⁷ is an alkyl group comprising from 1 to 4 carbon atoms;
   and
   R⁶ is selected from:
a hydrogen atom;
an alkyl group comprising 1 to 4 carbon atoms optionally substituted by a hydroxyl group; or
a group —CO₂R⁸ wherein R⁸ is selected from a hydrogen atom or an alkyl group comprising from 1 to 4 carbon atoms;
   and m is an integer.

Suitably, R⁴ is selected from a hydrogen atom, an alkali metal cation, an ammonium ion or an amine residue. Suitably R⁴ is a hydrogen atom.

Suitably, R⁵ and R⁶ are each independently selected from a hydrogen atom or a methyl group. Suitably R⁵ and R⁶ are hydrogen atoms.

Suitably, m is an integer from 2 to 300, suitably from 2 to 200, suitably from 5 to 100.

Suitably R⁴ and R⁶ are hydrogen atoms and R⁵ is selected from a hydrogen atom or a methyl group.

Suitably, the method comprises treating a scrubber media by addition of a polycarboxylic acid composition which comprises a polymer having a homopolymer chain consisting of units of formula (I).

Suitably, the method comprises treating a scrubber media by addition of a polycarboxylic acid composition which comprises a copolymer.

Suitably, the method comprises treating a scrubber media by addition of a polycarboxylic acid composition which comprises a polymer having at least one unit of formula (I) and at least one unit of formula (II):

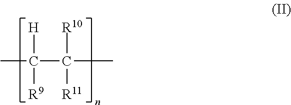

wherein:
R⁹ is selected from:
a hydrogen atom;
a methyl group; or
a group —CO₂R¹² wherein R¹² is selected from a hydrogen atom or an alkyl group comprising from 1 to 8 carbon atoms;
   R¹⁰ is selected from:
a hydrogen atom;
an alkyl group comprising from 1 to 4 carbon atoms;
a hydroxymethyl group; or
a group —CO₂R¹³ wherein R¹³ is selected from a hydrogen atom or an alkyl group comprising from 1 to 8 carbon atoms;
   R¹¹ is selected from:
a sulfonate containing group;
a residue —CO₂R¹⁴ wherein R¹⁴ is selected from a hydrogen atom or an alkyl group comprising from 1 to 4 carbon atoms;
a straight or branched alkyl residue having 1 to 8 carbon atoms optionally substituted by one to three carboxylic acid groups;
a phenyl residue;
an acetoxy residue;
hydroxymethyl;
an acetoxymethyl residue;
—SO₃M, —CH₂SO₃M, —PO₃M₂ or PO₃M′₂ in which M is selected from hydrogen, an alkali metal or an alkaline earth metal and each M′ is M or C₁-C₄ alkyl;
a residue —CONR¹⁵R¹⁶ wherein R¹⁵ and R¹⁶ are the same or different and each is selected from hydrogen, a straight or branched chain alkyl residue having 1 to 8 carbon atoms, hydroxymethyl or a residue —CH(OH)—CO₂M, —C(CH₃)₂CH₂SO₃M or —C(CH₃)₂CH₂PO₃M₂ in which M is selected from hydrogen, an alkali metal or alkaline earth metal; or
—N(R¹⁷)COCH₃ in which R¹⁷ is selected from hydrogen or C₁-C₄ straight or branched chain alkyl;
   and n is an integer.

Suitably, R⁹ and R¹⁰ are each independently selected from a hydrogen atom or a methyl group. Suitably R⁹ and R¹⁰ are hydrogen atoms.

Suitably, m is an integer from 2 to 300, suitably 2 to 200, suitably from 5 to 100.

Suitably, R¹¹ is a residue —CONR¹⁵R¹⁶ wherein R¹⁵ and R¹⁶ are the same or different and each is selected from hydrogen, a straight or branched chain alkyl residue having 1 to 8 carbon atoms, hydroxymethyl or a residue —CH(OH)—CO₂M, —C(CH₃)₂CH₂SO₃M or —C(CH₃)₂CH₂PO₃M₂ in which M is selected from hydrogen, an alkali metal or alkaline earth metal.

Suitably, R¹¹ is a sulfonate containing group and is selected from:
a group —(CH₂)ₓSO₃M wherein M is selected from a hydrogen atom, an alkali metal or an alkaline earth metal, x is 0 or is an integer having a value of from 1 to 4;
a group having the formula —CONHC(CX₃)₂CH₂SO₃M wherein X is selected from a hydrogen atom or a methyl group and M is selected from a hydrogen atom, an alkali metal or an alkaline earth metal;
a phenyl sulfonic acid group —C₆H₄SO₃M in which M is selected from a hydrogen atom, an alkali metal or an alkaline earth metal; or
a group having the formula —CH₂O—[CY₂]_{z}SO₃M wherein Y is selected from a hydrogen atom, a hydroxyl group or a methyl group, z is an integer having a value of from 1 to 4 and M is selected from a hydrogen atom, an alkali metal or an alkaline earth metal.

Suitably, R¹¹ is —C(CH₃)₂CH₂SO₃M in which M is selected from hydrogen, an alkali metal or alkaline earth metal.

Suitably, R¹¹ is —C(CH₃)₂CH₂SO₃M in which M is selected from hydrogen, an alkali metal or alkaline earth metal and R⁹ and R¹⁰ are hydrogen atoms.

Suitably, the scrubber media comprises a polycarboxylic acid composition which comprises a copolymer having at least one unit of formula (I) and at least one unit of formula (II).

Suitably, the scrubber media comprises a polycarboxylic acid composition which comprises a combination of: (i) a polymer having units of formula (I); and (ii) a copolymer having units of formula (I) and (II). Suitably, said polymers are water soluble. Suitably, said polymers have a molecular weight such that they are water soluble.

Suitably, the polycarboxylic acid composition comprises a polymer having units of formula (I) and which comprises a chain transfer agent. Suitably, the polycarboxylic acid composition comprises a polymer having units of formula (I) and units of formula (II) and which comprises a chain transfer agent.

Suitably, the polycarboxylic acid composition comprises a polycarboxylic acid homopolymer. The polycarboxylic acid composition may comprise an acrylic acid homopolymer. Suitably, the polycarboxylic acid composition comprises a polycarboxylic acid copolymer. Suitably, the polycarboxylic acid composition comprises a copolymer of carboxylic acid and sulfonic acid.

Suitably, the polycarboxylic acid composition comprises a copolymer of acrylic acid and 2-acrylamido-2-methylpropane sulfonic acid (AMPS).

Suitably, the polycarboxylic acid composition comprises a phosphorus containing polymer.

Suitably, the polycarboxylic acid composition comprises a combination of two or more phosphorus containing polymers.

Suitably, according to the present invention there is provided a scrubber media comprising a polymer having formula (III):

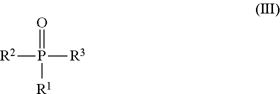

wherein:
R¹ is a residue —OX wherein X is selected from a hydrogen atom, an alkali metal or alkaline earth metal cation, an ammonium ion or an amine residue;
R² is a polymeric residue comprising at least one unit of formula (I):

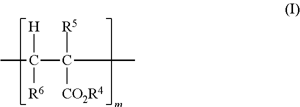

and optionally at least one unit of formula (II):

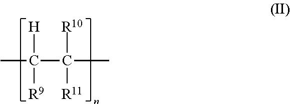

wherein R⁴, R⁵, R⁶, R⁹, R¹⁰ and R¹¹ in formula (I) and (II) are as defined above; and wherein:
R³ is selected from:
a residue —OX wherein X is selected from a hydrogen atom, an alkali metal or alkaline earth metal cation, an ammonium ion or an amine residue;
a hydrogen atom; or
a polymeric residue comprising at least one unit of formula (I) and optionally at least one unit of formula (II) and wherein formula (I) and formula (II) are as defined in relation to R² and wherein m and n are integers and the values of m and n in R³ are the same or different from the values of m and n in R².

Suitably, in R² m is an integer having a value of from 1 to 300, suitably 1 to 200, suitably 5 to 100. Suitably, in R² n is an integer having a value of from 1 to 300, suitably 1 to 200, suitably 5 to 100. Suitably, in R² n and m are integers and the sum of n+m is an integer having a value of from 3 to 300, suitably 3 to 200, suitably 5 to 100. Suitably, in R² the ratio of n:m, where n is present, is in the range 99:1 to 1:99.

Suitably, in R³ m is an integer having a value of from 1 to 300, suitably 1 to 200, suitably 5 to 100. Suitably, in R³ n is an integer having a value of from 1 to 300, suitably 1 to 200, suitably 5 to 100. Suitably, in R³ n and m are integers and the sum of n+m is an integer having a value of from 3 to 300, suitably 3 to 200, suitably 5 to 100. Suitably, in R³ the ratio of n:m, where n is present, is in the range 99:1 to 1:99.

Suitably, the polycarboxylic acid composition comprises a polymer which may conveniently be produced by the reaction of m moles of a compound having the formula (IV), wherein R⁴ is preferably a hydrogen atom:

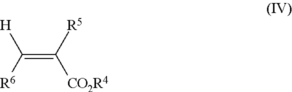

optionally with n moles of a compound having the formula (V):

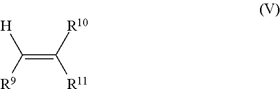

wherein R⁴, R⁵, R⁶, R⁹, R¹⁰ and R¹¹, n and m are as defined above,
suitably, with a chain transfer agent.

The chain transfer agent may for example be selected from: a phosphorous species, for example phosphorous acid and its salts, hypophosphorous acid and its salts; mercaptans; ferric salts; cupric salts; bisulfites; and lower alcohols, for example isopropanol.

Suitably, the polycarboxylic acid composition comprises a polymer which may conveniently be produced by the reaction of m moles of a compound having the formula (IV) optionally with n moles of a compound having the formula (V) and suitably with one molar proportion of hypophosphorus acid or a hypophosphite.

Suitably, the method comprises treating a scrubber media by addition of a polycarboxylic acid composition which comprises homopolymeric phosphinopoly(meth) acrylic acid having the formula (VI):

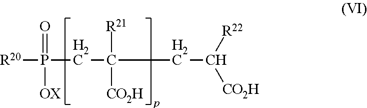

wherein X is selected from a hydrogen atom or an alkali metal cation, R²¹ is selected from a hydrogen atom or a methyl group, R²² is selected from a hydrogen atom or a methyl group and R²⁰ is selected from a hydrogen atom or a group of formula (VII):

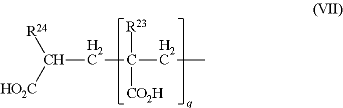

wherein R²³ is selected from a hydrogen atom or a methyl group, R²⁴ is selected from a hydrogen atom or a methyl group;
and wherein p and q are integers.

Suitably, the method comprises treating a scrubber media by addition of a polycarboxylic acid composition which comprises a copolymeric phosphinopolycarboxylic acid (A) having the formula (III) wherein in the unit of formula (II) R¹¹ is selected from:
a group —(CH₂)—SO₃M wherein M is selected from a hydrogen atom, an alkali metal cation or an alkaline earth metal cation, x is 0 or an integer having a value of from 1 to 4;
a group having the formula —CONHC(CX₃)₂CH₂SO₃M wherein X is selected from a hydrogen atom or a methyl group and wherein M is selected from a hydrogen atom, an alkali metal cation or an alkaline earth metal cation;
a phenyl sulfonic acid group —C₆H₄SO₃M and wherein M is selected from a hydrogen atom, an alkali metal cation or an alkaline earth metal cation; or
a group having the formula CH₂—O—[CY₂]_{z}SO₃M wherein Y is selected from a hydrogen atom a hydroxyl group or a methyl group and _{z} is an integer having a value of from 1 to 4 and wherein M is selected from a hydrogen atom, an alkali metal cation or an alkaline earth metal cation.

Suitably, in the copolymeric phosphinopolycarboxylic acid (A) in the unit of formula (II) R¹¹ comprises a group having the formula —CONHC(CX₃)₂CH₂SO₃M wherein X is selected from a hydrogen atom or a methyl group and wherein M is selected from a hydrogen atom, an alkali metal cation or an alkaline earth metal cation.

Suitably, in the copolymeric phosphinopolycarboxylic acid (A) in the unit of formula (II) R¹¹ comprises a group having the formula —CONHC(CH₃)₂CH₂SO₃M wherein M is selected from a hydrogen atom, an alkali metal cation or an alkaline earth metal cation. Suitably, M is a hydrogen atom.

Suitably, in the copolymeric phosphinopolycarboxylic acid (A) in the unit of formula (II) R⁹ and R¹⁰ are hydrogen atoms.

Suitably, in the copolymeric phosphinopolycarboxylic acid (A) in the unit of formula (I) R⁵ and R⁶ are each independently selected from a hydrogen atom or a methyl group. Suitably R⁵ and R⁶ are hydrogen atoms.

Suitably, in the copolymeric phosphinopolycarboxylic acid (A) in the unit of formula (I) R⁴ is selected from a hydrogen atom or an alkali metal cation, an ammonium ion or an amine residue. Suitably R⁴ is a hydrogen atom.

Suitably, the method comprises treating a scrubber media by addition of a polycarboxylic acid composition comprising a combination of a homopolymeric phosphinopoly(meth) acrylic acid having the formula (VI) as defined above and a copolymeric phosphinopolycarboxylic acid (A) as defined above.

Suitably, the method comprises treating a scrubber media by addition of a polycarboxylic acid composition comprising a polymer according to formula (III) in which some of the acidic hydrogens in the polymer have been replaced by cations derived from salt forming bases of alkali metals or alkaline earth metals.

Suitably, the method comprises treating a scrubber media by addition of polycarboxylic acid composition comprising a phosphorus containing polymer having formula (III) as defined in relation to the first aspect.

Suitably, the method comprises treating a scrubber media by addition of a polycarboxylic acid composition having any feature as described in relation to the first aspect.

The polycarboxylic acid composition may comprise partially neutralised polycarboxylic acids.

Suitably, the method comprises neutralising a polycarboxylic acid composition to between pH 8 and pH 9 prior to addition to the scrubber media. Suitably, the method comprises adding a polycarboxylic acid composition having a pH adjusted to between pH 8.0 and pH 9.0 to the scrubber media.

Suitably, the method comprises adding polycarboxylic acid to the scrubber media in an amount of at least 10 ppm by weight, suitably at least 50 ppm by weight, for example at least 100 ppm by weight.

Suitably, the method comprises adding polycarboxylic acid to the scrubber media in an amount of at least 200 ppm by weight, for example at least: 300 ppm; 400 ppm; 500 ppm; 600 ppm; 700 ppm; 800 ppm; 900 ppm; 1000 ppm; 1100 pm 1200 ppm; 1300 ppm; 1400 ppm; 1500 ppm; 1600 ppm; 1700 ppm; 1800 ppm; 1900 ppm or 2000 ppm by weight.

Suitably, the method comprises adding polycarboxylic acid to the scrubber media in an amount of no more than 5000 ppm; suitably no more than 4000 ppm, for example no more than 3000 ppm.

Suitably, the method comprises adding polycarboxylic acid to the scrubber media in an amount of between 1000 ppm and 3000 ppm by weight, for example between 1500 ppm and 2500 ppm by weight.

Suitably, the method comprises adding a polymer P1 having formula (III-P1) to a scrubber media wherein formula (III-P1) is as defined in relation to the first aspect.

Suitably, the method comprises adding a polymer P2 having formula (III-P2) to a scrubber media wherein formula (III-P2) is as defined in relation to the first aspect.

Suitably, the method comprises adding a polycarboxylic acid composition comprising a combination of polycarboxylic acids to a scrubber media.

Suitably, the method comprises adding a combination of polymer P1 and polymer P2 to a scrubber media.

Suitably, the method comprises adding a combination of polymer P1 and polymer P2 to a scrubber media wherein the weight ratio of P1 to P2 added to the scrubber media is from 1:9 to 9:1, suitably from 1:2 to 2:1, for example 1:1.

Suitably, the method comprises adding a combination of a phosphino homopolymer of acrylic acid and a phosphino copolymer of acrylic acid and 2-acrylamido-2-methylpropane sulfonic acid (AMPS) to a scrubber media.

Suitably, the method comprises adding a combination of (i) a phosphino homopolymer of acrylic acid and (ii) a phosphino copolymer of acrylic acid and 2-acrylamido-2-methylpropane sulfonic acid (AMPS) to a scrubber media wherein the weight ratio of (i) to (ii) added to the scrubber media is from 1:9 to 9:1, suitably from 1:2 to 2:1, for example 1:1.

Suitably, the method comprises adding a combination of polymer P1 and polymer P2 to the scrubber media in an amount of at least 10 ppm by weight, suitably at least 50 ppm by weight, for example at least 100 ppm by weight, for example at least 1000 ppm by weight.

Suitably, the method comprises adding a combination of (i) a phosphino homopolymer of acrylic acid and (ii) a phosphino copolymer of acrylic acid and 2-acrylamido-2-methylpropane sulfonic acid (AMPS) to the scrubber media in a combined amount of at least 10 ppm by weight, suitably at least 50 ppm by weight, for example at least 100 ppm by weight, for example at least 1000 ppm by weight.

Suitably, the method comprises adding an aqueous solution of polycarboxylic acids to the scrubber media. The method may comprise adding an aqueous solution of phosphorus containing polycarboxylic acids to the scrubber media.

Suitably, the method comprises adding a polycarboxylic acid composition comprising a phosphorus containing polymer composition to a scrubber media. Suitably, the method comprises adding an aqueous polycarboxylic acid composition comprising a combination of two or more phosphorus containing polymers to a scrubber media.

Suitably, the method comprises adding a polycarboxylic acid composition to the scrubber media to extend the operating life of the scrubber media.

Surprisingly, it has been found that the addition of a polycarboxylic acid composition to a scrubber media may prolong the effective life of the scrubber media.

Suitably, the method comprises adding a polycarboxylic acid composition to a scrubber media for use to increase the time interval before the scrubber media needs to be replaced in use in comparison to scrubber media absent said polycarboxylic acid composition. Suitably, said replacement interval may be at least 20% longer than required for scrubber media absent a polycarboxylic acid composition. Suitably, said replacement window may be 50% longer, for example: 100%; 150%; or 200% longer.

Suitably, the method comprises adding a polycarboxylic acid composition to a scrubber media for use to increase the amount of hydrogen sulfide and/or mercaptans which can be captured by a given volume of scrubber media before said media becomes saturated.

Suitably, the method comprises adding a polycarboxylic acid composition to a scrubber media for use to increase the volume of gas having a given concentration of hydrogen sulfide and/or mercaptans which can be passed through a given volume of scrubber media before said media becomes saturated.

Suitably, the method comprises adding a polycarboxylic acid composition to a scrubber media for use to reduce the formation of back pressure in a scrubber.

Suitably, the method comprises adding a polycarboxylic acid composition to a scrubber media for use to inhibit the formation of scale in a scrubber.

Suitably, the method comprises adding a polycarboxylic acid composition to a scrubber media for use to reduce the rate of formation of salt deposits in a scrubber.

Suitably, the method comprises adding a polycarboxylic acid composition to a scrubber media for use to inhibit the formation of salt deposits in a scrubber.

Suitably, the method comprises adding a polycarboxylic acid composition to a scrubber media for use to reduce the rate of formation of sodium carbonate deposits in a scrubber.

Suitably, the method comprises adding a polycarboxylic acid composition to a scrubber media for use to inhibit the formation of sodium carbonate deposits in a scrubber.

Suitably, the method comprises adding a polycarboxylic acid composition to a scrubber media for use to alleviate the need to clean out the scrubber unit.

Suitably, the method comprises adding a polycarboxylic acid composition to a scrubber media adapted to treat a gas stream from a storage tank, for example a tar oil storage tank. The method may comprise adding a polycarboxylic acid composition to a scrubber media adapted to treat an air stream, for example an air stream comprising hydrogen sulfide contaminant.

Suitably, the method comprises adding a polycarboxylic acid composition to a scrubber media adapted to treat a gas stream comprising hydrogen sulfide. Suitably, the method comprises adding a polycarboxylic acid composition to a scrubber media adapted to treat a gas stream comprising mercaptans. Suitably, the method comprises adding a polycarboxylic acid composition to a scrubber media adapted to treat a gas stream comprising C₁-C₆ mercaptans. Suitably, the method comprises adding a polycarboxylic acid composition to a scrubber media adapted to treat a gas stream comprising C₅-C₈ VOCs. Suitably, the method comprises adding a polycarboxylic acid composition to a scrubber media adapted to treat a gas stream comprising hydrogen sulfide and mercaptans.

Suitably, the method comprises adding a polycarboxylic acid composition to a scrubber media adapted to capture hydrogen sulfide. Suitably, the method comprises adding a polycarboxylic acid composition to a scrubber media adapted to capture mercaptans. Suitably, the method comprises treating a scrubber media adapted to capture C₁-C₆ mercaptans.

Suitably, the scrubber media comprises a scavenger additive. Suitably, the scrubber media comprises sodium hydroxide.

Suitably, the method comprises adding a polycarboxylic acid composition to a scrubber media comprising sodium hydroxide. Suitably, the method comprises adding a polycarboxylic acid composition to a scrubber media comprising water. Suitably, the method comprises adding a polycarboxylic acid composition to a scrubber media comprising sodium hydroxide and water. The method may comprise adding a polycarboxylic acid composition to a scrubber media consisting of sodium hydroxide and water.

Suitably, the method comprises treating a scrubber media comprising sodium hydroxide by addition of a polycarboxylic acid composition to provide a treated scrubber media which comprises sodium hydroxide and a polycarboxylic acid composition.

Suitably, the method comprises treating a scrubber media which comprises a scavenger additive, suitably sodium hydroxide, in an amount of at least 10% by weight.

Suitably, the method comprises treating a scrubber media which comprises a scavenger additive, suitably sodium hydroxide, in an amount of at least 15% by weight; for example at least 20%; 25%; 30%; 35%; 40%; 45% or 50% by weight.

Suitably, the method comprises treating a scrubber media which comprises a scavenger additive, suitably sodium hydroxide, in an amount of no greater than 80% by weight.

Suitably, the method comprises treating a scrubber media which comprises a scavenger additive, suitably sodium hydroxide, in an amount of no greater than 75% by weight, for example no more than: 70%; 65%; 60%; 55% or 50% by weight.

Suitably, the method comprises treating a scrubber media which comprises a scavenger additive, suitably sodium hydroxide, in an amount of between 30% and 70% by weight, for example between 40% and 60% by weight.

The method may comprise treating a scrubber media which comprises an amine. The method may comprise treating a scrubber media which comprises a complex amine.

Suitably, the method comprises treating a scrubber media which comprises an aqueous media. Suitably, the method comprises treating a scrubber media which comprises water in an amount of at least 20% by weight.

Suitably, the method comprises treating a scrubber media which comprises water in an amount of at least 25% by weight; for example, at least: 30%; 35%; 40%; 45% or 50% by weight.

Suitably, the method comprises treating a scrubber media which comprises water in an amount of no more than 90% by weight.

Suitably, the method comprises treating a scrubber media which comprises water in an amount of no more than 85% by weight, for example no more than: 80%; 75%; 70%; 65%; 60% or 65% by weight.

Suitably, the method comprises treating a scrubber media which comprises water in an amount of between 20% and 80% by weight, for example between 40% and 60% by weight.

Suitably, the method comprises treating a scrubber media by addition of one or more phosphino polycarboxylic acids or salts thereof to said scrubber media.

Suitably, the method comprises treating a scrubber media by addition of one or more phosphono polycarboxylic acids or salts thereof to said scrubber media.

Suitably, the method comprises adding a combination of polycarboxylic acids to a scrubber media. Suitably, the method comprises adding a combination of phosphorus containing polycarboxylic acids to a scrubber media. Suitably, the method comprises adding a combination of phosphino polycarboxylic acids or salts thereof and/or phosphono polycarboxylic acids or salts thereof to a scrubber media. Suitably, the method comprises adding a combination of phosphino polycarboxylic acids or salts thereof to a scrubber media. Suitably, the method comprises adding polymers P1 and P2 as defined in relation to the first aspect to a scrubber media. Suitably, the method comprises adding a combination of (i) a phosphino homopolymer of acrylic acid and (ii) a phosphino copolymer of acrylic acid and 2-acrylamido-2-methylpropane sulfonic acid (AMPS) to a scrubber media.

Suitably, the method comprises providing a treated scrubber media which comprises water, sodium hydroxide and one or more polycarboxylic acids. Suitably, the method comprises providing a treated scrubber media which comprises water, sodium hydroxide and one or more phosphorus containing polymers. Suitably, the method comprises providing a treated scrubber media which comprises water, sodium hydroxide and a combination of polycarboxylic acids. Suitably, the method comprises providing a treated scrubber media which comprises water, sodium hydroxide and a combination of phosphorus containing polymers. Suitably, the method comprises providing a treated scrubber media which comprises water, sodium hydroxide and a combination of phosphino polycarboxylic acids or salts thereof and/or phosphono polycarboxylic acids or salts thereof. Suitably, the method comprises providing a treated scrubber media which comprises water, sodium hydroxide and a combination of phosphino polycarboxylic acids or salts thereof. Suitably, the method comprises providing a treated scrubber media which comprises water, sodium hydroxide and polymers P1 and P2 as defined in relation to the first aspect. Suitably, the method comprises providing a treated scrubber media which comprises water, sodium hydroxide and a combination of (i) a phosphino homopolymer of acrylic acid and (ii) a phosphino copolymer of acrylic acid and 2-acrylamido-2-methylpropane sulfonic acid (AMPS).

The method may comprise providing a scrubber media having any feature or combination of features as described in relation to the first aspect except where such features are mutually exclusive.

According to a third aspect of the present invention there is provided a scrubber apparatus comprising a scrubber unit containing a scrubber media and wherein said scrubber media comprises a polycarboxylic acid composition.

Suitably, the scrubber apparatus comprises a scrubber unit containing scrubber media which comprises a scrubber media according to the first aspect.

Suitably, the scrubber apparatus comprises a scrubber unit containing scrubber media which consists of a scrubber media according to the first aspect.

Suitably, the scrubber apparatus comprises a scrubber unit containing scrubber media which has been treated according to the method of the second aspect.

Suitably, the apparatus comprises a scrubber media comprising a polymer P1 having formula (III-P1) wherein formula (III-P1) is as defined in relation to the first aspect.

Suitably, the apparatus comprises a scrubber media comprising a polymer P2 having formula (III-P2) wherein formula (III-P2) is as defined in relation to the first aspect.

Suitably, the apparatus comprises a scrubber media comprising a combination of polycarboxylic acids.

Suitably, the apparatus comprises a scrubber media comprising a combination of polymer P1 and polymer P2.

Suitably, the apparatus comprises a scrubber media comprising a combination of polymer P1 and polymer P2 wherein the weight ratio of P1 to P2 in the scrubber media is from 1:9 to 9:1, suitably from 1:2 to 2:1, for example 1:1.

Suitably, the apparatus comprises a scrubber media comprising a combination of a phosphino homopolymer of acrylic acid and a phosphino copolymer of acrylic acid and 2-acrylamido-2-methylpropane sulfonic acid (AMPS).

Suitably, the apparatus comprises a scrubber media comprising a combination of (i) a phosphino homopolymer of acrylic acid and (ii) a phosphino copolymer of acrylic acid and 2-acrylamido-2-methylpropane sulfonic acid (AMPS) wherein the weight ratio of (i) to (ii) in the scrubber media is from 1:9 to 9:1, suitably from 1:2 to 2:1, for example 1:1.

Suitably, the scrubber apparatus comprises scrubber media comprising a polycarboxylic acid composition having any feature as described in relation to the first aspect.

The scrubber apparatus may comprise a forced induction scrubber unit.

Suitably, the scrubber apparatus is adapted to treat a gas stream from a storage tank, for example a tar oil storage tank. Suitably, the scrubber apparatus is adapted to treat an air stream, for example an air stream comprising hydrogen sulfide contaminant.

Suitably, the scrubber apparatus is adapted to treat a gas stream comprising hydrogen sulfide. Suitably, the scrubber apparatus is adapted to treat a gas stream comprising mercaptans. Suitably, the scrubber apparatus is adapted to treat a gas stream comprising C₁-C₆ mercaptans. Suitably, the scrubber apparatus is adapted to treat a gas stream comprising VOCs. Suitably, the scrubber apparatus is adapted to treat a gas stream comprising C₅-C₈ VOCs. Suitably, the scrubber media is adapted to treat a gas stream comprising hydrogen sulfide and mercaptans.

Suitably, the scrubber apparatus is adapted to capture hydrogen sulfide. Suitably, the scrubber apparatus is adapted to capture mercaptans. Suitably, the scrubber apparatus is adapted to capture C₁-C₆ mercaptans. The scrubber apparatus may be adapted to capture VOCs. The scrubber apparatus may be adapted to capture C₅-C₈ VOCs. Suitably, the scrubber apparatus is adapted to capture hydrogen sulfide and mercaptans.

Suitably, the scrubber apparatus comprises a scrubber unit containing a scrubber media comprising a scavenger additive. Suitably, the scrubber apparatus comprises a scrubber unit containing a scrubber media which comprises sodium hydroxide. Suitably, the scrubber apparatus comprises a scrubber unit containing a scrubber media which comprises sodium hydroxide and a polycarboxylic acid composition.

Suitably, the scrubber apparatus comprises a scrubber unit containing a scrubber media which comprises water, sodium hydroxide and one or more polycarboxylic acids. Suitably, the scrubber apparatus comprises a scrubber unit containing a scrubber media which comprises water, sodium hydroxide and a combination of polycarboxylic acids. Suitably, the scrubber apparatus comprises a scrubber unit containing a scrubber media which comprises water, sodium hydroxide and a combination of phosphino polycarboxylic acids or salts thereof and/or phosphono polycarboxylic acids or salts thereof. Suitably, the scrubber apparatus comprises a scrubber unit containing a scrubber media which comprises water, sodium hydroxide and a combination of phosphino polycarboxylic acids or salts thereof. Suitably, the scrubber apparatus comprises a scrubber unit containing a scrubber media which comprises water, sodium hydroxide and polymers P1 and P2 as defined in relation to the first aspect. Suitably, the scrubber apparatus comprises a scrubber unit containing a scrubber media which comprises water, sodium hydroxide and a combination of (i) a phosphino homopolymer of acrylic acid and (ii) a phosphino copolymer of acrylic acid and 2-acrylamido-2-methylpropane sulfonic acid (AMPS).

The scrubber apparatus may comprise a plurality of scrubber units.

Suitably, the scrubber apparatus comprises a first scrubber unit containing a media adapted to capture hydrogen sulfide. Suitably, the scrubber apparatus comprises a first scrubber unit containing a media adapted to capture mercaptans. Suitably, the scrubber apparatus comprises a first scrubber unit containing a media adapted to capture C₁-C₆ mercaptans. The first scrubber unit may be located to be the most upstream scrubber unit.

Suitably, the scrubber apparatus comprises a first scrubber unit containing a scrubber media which comprises a polycarboxylic acid composition. Suitably, the scrubber apparatus comprises a first scrubber unit containing a scrubber media which comprises sodium hydroxide. Suitably, the scrubber apparatus comprises a first scrubber unit containing a scrubber media which comprises sodium hydroxide and a polycarboxylic acid composition.

The scrubber apparatus may comprise a second scrubber unit containing a media adapted to capture VOCs and/or mercaptans. The scrubber apparatus may comprise a second scrubber unit containing a media adapted to capture C₁-C₆ mercaptans. The scrubber apparatus may comprise a second scrubber unit containing a media adapted to capture C₅-C₈ VOCs. The second scrubber unit may be located downstream of the first scrubber unit.

The scrubber apparatus may comprise a third scrubber unit containing a media adapted to capture VOCs. The scrubber apparatus may comprise a third scrubber unit containing a media adapted to capture C₅-C₈ VOCs. The third scrubber unit may be located downstream of the second scrubber unit.

The apparatus may be adapted to receive gas from a storage tank. The apparatus may be adapted to receive vapours from a storage tank, for example a tar oil storage tank.

The scrubber apparatus may comprise any feature or combination of features as described in relation to the first, second or fourth aspects except where such features are mutually exclusive.

According to a fourth aspect of the present invention there is provided a method of removing constituents from a gas stream, wherein the method comprises introducing a gas stream into a scrubber media and wherein said scrubber media comprises a polycarboxylic acid composition.

Suitably, the method comprises introducing a gas stream into a scrubber media which comprises a scrubber media according to the first aspect.

Suitably, the method comprises introducing a gas stream into a scrubber media which consists of a scrubber media according to the first aspect.

Suitably, the method comprises introducing a gas stream into a scrubber media which has been treated according to the method of the second aspect.

Suitably, the method comprises introducing a gas stream into a scrubber media which comprises a polymer P1 having formula (I-P1) wherein formula (I-P1) is as defined in relation to the first aspect.

Suitably, the method comprises introducing a gas stream into a scrubber media which comprises a polymer P2 having formula (I-P2) wherein formula (I-P2) is as defined in relation to the first aspect.

Suitably, the method comprises introducing a gas stream into a scrubber media which comprises a combination of polycarboxylic acids.

Suitably, the method comprises introducing a gas stream into a scrubber media which comprises a combination of a polymer P1 and a polymer P2.

Suitably, the method comprises introducing a gas stream into a scrubber media which comprises a combination of a polymer P1 and a polymer P2 wherein the weight ratio of P1 to P2 in the scrubber media is from 1:9 to 9:1, suitably from 1:2 to 2:1, for example 1:1.

Suitably, the method comprises introducing a gas stream into a scrubber media which comprises a combination of a phosphino homopolymer of acrylic acid and a phosphino copolymer of acrylic acid and 2-acrylamido-2-methylpropane sulfonic acid (AMPS).

Suitably, the method comprises introducing a gas stream into a scrubber media which comprises a combination of (i) a phosphino homopolymer of acrylic acid and (ii) a phosphino copolymer of acrylic acid and 2-acrylamido-2-methylpropane sulfonic acid (AMPS) wherein the ratio of weight ratio of (i) to (ii) in the scrubber media is from 1:9 to 9:1, suitably from 1:2 to 2:1, for example 1:1.

Suitably, the method comprises introducing a gas stream into a scrubber media which comprises a polycarboxylic acid composition having any feature as described in relation to the first aspect.

Suitably, the method comprises using an aqueous scrubber media. Suitably, the method comprises using a scrubber media comprising a scavenger additive. Suitably, the method comprises using a scrubber media comprising sodium hydroxide. Suitably, the method comprises using a scrubber media which comprises sodium hydroxide and a polycarboxylic acid composition.

Suitably, the method comprises using a scrubber media which comprises water, sodium hydroxide and one or more polycarboxylic acids. Suitably, the method comprises using a scrubber media which comprises water, sodium hydroxide and a combination of polycarboxylic acids. Suitably, the method comprises using a scrubber media which comprises water, sodium hydroxide and a combination of phosphino polycarboxylic acids or salts thereof and/or phosphono polycarboxylic acids or salts thereof. Suitably, the method comprises using a scrubber media which comprises water, sodium hydroxide and a combination of phosphino polycarboxylic acids or salts thereof. Suitably, the method comprises using a scrubber media which comprises water, sodium hydroxide and polymers P1 and P2 as defined in relation to the first aspect. Suitably, the method comprises using a scrubber media which comprises water, sodium hydroxide and a combination of (i) a phosphino homopolymer of acrylic acid and (ii) a phosphino copolymer of acrylic acid and 2-acrylamido-2-methylpropane sulfonic acid (AMPS).

Suitably, the method comprises treating a scrubber media comprising sodium hydroxide by addition of a polycarboxylic acid composition.

Suitably, the method comprises treating a scrubber media according to the method of the second aspect.

Suitably, the method comprises introducing a gas stream into a scrubber media contained in a scrubber unit.

Suitably, the method uses a scrubber apparatus according to the third aspect.

Suitably, the method comprises treating a gas stream from a storage tank, for example a tar oil storage tank. Suitably, the method comprises treating an air stream, for example an air stream comprising hydrogen sulfide contaminant.

Suitably, the method comprises treating a gas stream comprising hydrogen sulfide. Suitably, the method comprises treating a gas stream comprising mercaptans. Suitably, the method comprises treating a gas stream comprising C₁-C₆ mercaptans. Suitably, the method comprises treating a gas stream comprising VOCs. Suitably, the method comprises treating a gas stream comprising C₅-C₈ VOCs. Suitably, the method comprises treating a gas stream comprising hydrogen sulfide and mercaptans.

Suitably, the method comprises removing hydrogen sulfide from a gas stream. Suitably, the method comprises removing mercaptans from a gas stream. Suitably, the method comprises removing C₁-C₆ mercaptans from a gas stream. The method may comprise removing VOCs from a gas stream. The method may comprise removing C₅-C₈ VOCs from a gas stream. Suitably, the method comprises removing hydrogen sulfide and mercaptans from a gas stream.

The method may comprise passing a gas stream through a plurality of scrubber units.

Suitably, the method comprises passing a gas stream through a first scrubber unit containing a media adapted to capture hydrogen sulfide. Suitably, the method comprises passing a gas stream through a first scrubber unit containing a media adapted to capture mercaptans. Suitably, the method comprises passing a gas stream through a first scrubber unit containing a media adapted to capture C₁-C₆ mercaptans. The method may comprise passing a gas stream through a first scrubber unit located to be the most upstream scrubber unit.

Suitably, the method comprises passing a gas stream through a first scrubber unit containing a scrubber media which comprises a polycarboxylic acid composition. Suitably, the method comprises passing a gas stream through a first scrubber unit containing a scrubber media which comprises sodium hydroxide. Suitably, the method comprises passing a gas stream through a first scrubber unit containing a scrubber media which comprises sodium hydroxide and polycarboxylic acid composition.

The method may comprise passing a gas stream through a second scrubber unit containing a media adapted to capture VOCs and/or mercaptans. The method may comprise passing a gas stream through a second scrubber unit containing a media adapted to capture C₁-C₆ mercaptans. The method may comprise passing a gas stream through a second scrubber unit containing a media adapted to capture C₅-C₈ VOCs. The method may comprise passing a gas stream through a second scrubber located to be downstream of the first scrubber unit.

The method may comprise passing a gas stream through a third scrubber unit containing a media adapted to capture VOCs. The method may comprise passing a gas stream through a third scrubber unit containing a media adapted to capture C₅-C₈ VOCs. The method may comprise passing a gas stream through a third scrubber located to be downstream of the second scrubber unit.

The method may comprise any feature or combination of features as described in relation to the first, second or third aspects except where such features are mutually exclusive.

According to a fifth aspect of the present invention there is provided a polycarboxylic acid composition comprising a combination of two or more polycarboxylic acids for use to extend the operating life of a scrubber media.

Suitably, the polycarboxylic acid composition comprises an aqueous composition comprising a combination of two or more phosphorus containing polycarboxylic acids.

Suitably, the polycarboxylic acid composition comprises a pH between pH 8.0 and pH 9.0.

Suitably, the polycarboxylic acid composition comprises (i) a phosphinopolycarboxylic acid or salt thereof and/or a phosphonopolycarboxylic acid or salt thereof in combination with (ii) a phosphino carboxylic acid and sulfonic acid copolymer or salt thereof and/or a phosphono carboxylic acid and sulfonic acid copolymer or salt thereof.

Suitably, the polycarboxylic acid composition comprises a combination of a phosphorus containing polymer P1 having formula (I-P1) wherein formula (I-P1) is as defined in relation to the first aspect and a phosphorus containing polymer P2 having formula (I-P2) wherein formula (I-P2) is as defined in relation to the first aspect.

Suitably, the polycarboxylic acid composition comprises a combination of (i) a phosphino homopolymer of acrylic acid and (ii) a phosphino copolymer of acrylic acid and 2-acrylamido-2-methylpropane sulfonic acid (AMPS) wherein the weight ratio of (i) to (ii) in the phosphorus containing polymer composition is from 1:9 to 9:1, suitably from 1:2 to 2:1, for example 1:1.

Suitably, the polycarboxylic acid composition comprises a polycarboxylic acid composition having any feature as described in relation to the first and/or second aspect.

### DETAILED DESCRIPTION OF PREFERRED EMBODIMENTS

The present invention will now be illustrated by way of example by reference to the following embodiment.

### Example 1

In a test application a scrubber apparatus comprising three scrubber units was set up to receive gasses from a tar oil storage tank in order to control vapour emissions from the storage tank.

Gasses received from the storage tank contained odorous contaminates, after passing through the scrubber apparatus near odourless gas was returned to the storage tank. Gasses in the storage tank were the result of the equilibrium balance (vapour pressure) where at standard temperature and pressure light end gasses liberated from the stored tar oil.

The gas stream supplied from the storage tank to the scrubber apparatus comprised a combination of hydrogen sulfide, mercaptans (generally ranging from C₁-C₆) and VOCs (generally ranging from C₅-C₈) with the amount of each in the gas stream being in the region of 3000 to 5000 ppm or less.

The scrubber apparatus comprised a first scrubber for removing hydrogen sulfide from the gas stream supplied from the storage tank, a second scrubber for removing mercaptans from the gas stream and a third scrubber for removing VOCs from the gas stream. Each scrubber comprised a scrubber unit charged with a scrubber media. The apparatus also included a vacuum pump and ancillary components to remove gasses from the storage tank.

The hydrogen sulfide scrubber was set up in the primary position such that it was the first to receive gasses from the storage tank. The hydrogen sulfide scrubber unit comprised a 48 inch (122 cm) diameter scrubber unit having a capacity of 250 gallons (1137 litres).

The hydrogen sulfide scrubber unit was charged with an aqueous scrubber media comprising sodium hydroxide in an amount of 50% by weight. The scrubber media was treated by the addition of a combination of polycarboxylic acids in a combined amount of 2000 ppm. The polycarboxylic acids were added as a polycarboxylic acid composition which comprised a combination of (i) a phosphino homopolymer of acrylic acid and (ii) a phosphino copolymer of acrylic acid and 2-acrylamido-2-methylpropane sulfonic acid (AMPS) in a weight ratio of 1:1 and which had been neutralised to have a pH within the range of pH 8 to pH 9.

The test was run for 140 days without interruption and without any sign of significant salt deposits or generation of back pressure in the system.

### Example 2

### Comparative

In a comparative test a scrubber apparatus was set up to receive gasses from a tar oil storage tank. The apparatus was set up and operated in the same manner as that of Example 1 but the scrubber media in the hydrogen sulfide scrubber was different.

The hydrogen sulfide scrubber unit was charged with an aqueous scrubber media comprising sodium hydroxide in an amount of 50% by weight and no polycarboxylic acid composition was added. Within 30 days significant scaling was observed and it was necessary to remove and replace the scrubber media. Analysis showed the primary constituent of the scale to be sodium carbonate.

It will be appreciated that preferred embodiments of the present invention may extend the effective life of a scrubber media and may alleviate the need to frequently replace the scrubber media and clean out the scrubber unit.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A scrubber media comprising a polycarboxylic acid composition.

2. A scrubber media according to claim 1, wherein the scrubber media comprises sodium hydroxide and a combination of polycarboxylic acids.

3. A scrubber media according to claim 1, wherein the scrubber media comprises a polycarboxylic acid composition comprising a polymer having at least one unit of formula (I): 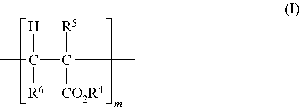
wherein:
R⁴ is selected from:
a hydrogen atom;
an alkali metal cation, an ammonium ion or an amine residue;
an alkyl group having from 1 to 4 carbon atoms; or
a phenyl group;
R⁵ is selected from:
a hydrogen atom;
a methyl group or a group —CO₂R⁷ wherein R⁷ is an alkyl group comprising from 1 to 4 carbon atoms;
and
R⁶ is selected from:
a hydrogen atom;
an alkyl group comprising 1 to 4 carbon atoms optionally substituted by a hydroxyl group; or
a group —CO₂R⁸ wherein R⁸ is selected from a hydrogen atom or an alkyl group comprising from 1 to 4 carbon atoms;
and m is an integer;
and optionally at least one unit of formula (II): 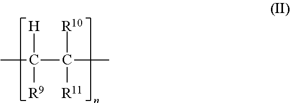
wherein:
R⁹ is selected from:
a hydrogen atom;
a methyl group; or
a group —CO₂R¹² wherein R¹² is selected from a hydrogen atom or an alkyl group comprising from 1 to 8 carbon atoms;
R¹⁰ is selected from:
a hydrogen atom;
an alkyl group comprising from 1 to 4 carbon atoms;
a hydroxymethyl group; or
a group —CO₂R¹³ wherein R¹³ is selected from a hydrogen atom or an alkyl group comprising from 1 to 8 carbon atoms;
R¹¹ is selected from:
a sulfonate containing group;
a residue —CO₂R¹⁴ wherein R¹⁴ is selected from a hydrogen atom or an alkyl group comprising from 1 to 4 carbon atoms;
a straight or branched alkyl residue having 1 to 8 carbon atoms optionally substituted by one to three carboxylic acid groups;
a phenyl residue;
an acetoxy residue;
hydroxymethyl;
an acetoxymethyl residue;
—SO₃M, —CH₂SO₃M, —PO₃M₂ or PO₃M′₂ in which M is selected from hydrogen, an alkali metal or an alkaline earth metal atom and M′ is M or C₁-C₄ alkyl;
a residue —CONR¹⁵R¹⁶ wherein R¹⁵ and R¹⁶ are the same or different and each is selected from hydrogen, a straight or branched chain alkyl residue having 1 to 8 carbon atoms, hydroxymethyl or a residue —CH(OH)—CO₂M, —C(CH₃)₂CH₂SO₃M or —C(CH₃)₂CH₂PO₃M₂ in which M is selected from hydrogen, an alkali metal or alkaline earth metal atom; or
—N(R¹⁷)COCH₃ in which R¹⁷ is selected from hydrogen or C₁-C₄ straight or branched chain alkyl;
and n is an integer.

4. A scrubber media according to claim 1, wherein the scrubber media comprises water, sodium hydroxide and a combination of phosphino and/or phosphono polycarboxylic acids or salts thereof.

5. A scrubber media according to claim 1, wherein the polycarboxylic acid composition comprises a combination of a polymer P1 and a polymer P2, wherein:
P1 has formula (III-P1): 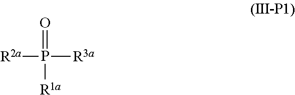
wherein:
R^{1a} is an —OX residue wherein X is selected from hydrogen or an alkali metal cation;
R^{2a} is a copolymer of acrylic acid and 2-acrylamido-2-methylpropane sulfonic acid (AMPS); and
R^{3a} is a copolymer of acrylic acid and 2-acrylamido-2-methylpropane sulfonic acid (AMPS) or
R^{3a} is an —OX residue wherein X is selected from hydrogen or an alkali metal cation; and
P2 has formula (III-P2): 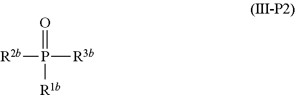
wherein
R^{1b} is an —OX residue wherein X is selected from hydrogen or an alkali metal cation;
R^{2b} is a homopolymer of acrylic acid or methacrylic acid; and
R^{3b} is a homopolymer of acrylic acid or methacrylic acid or R^{3b} is an —OX residue wherein X is selected from hydrogen or an alkali metal cation.

6. A scrubber media according to claim 1, wherein the scrubber media comprises a combination of a phosphino homopolymer of acrylic acid and a phosphino copolymer of acrylic acid and 2-acrylamido-2-methylpropane sulfonic acid (AMPS).

7. A scrubber media according to claim 1, wherein the scrubber media comprises water, sodium hydroxide and a combination of (i) a phosphino homopolymer of acrylic acid and (ii) a phosphino copolymer of acrylic acid and 2-acrylamido-2-methylpropane sulfonic acid (AMPS) wherein the ratio of weight ratio of (i) to (ii) in the scrubber media is from 1:2 to 2:1.

8. A scrubber media according to claim 7, wherein the scrubber media comprises an aqueous media comprising sodium hydroxide in an amount of at least 20% by weight and polycarboxylic acid in an amount of at least 100 ppm by weight.

9. A method of treating a scrubber media by addition of a polycarboxylic acid composition to said scrubber media.

10. A method according to claim 9, wherein the scrubber media comprises sodium hydroxide.

11. A method according to claim 9, wherein the method comprises treating a scrubber media by addition of a polycarboxylic acid composition comprising a polymer comprising at least one unit of formula (I): 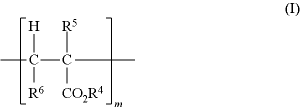
wherein:
R⁴ is selected from:
a hydrogen atom;
an alkali metal cation, an ammonium ion or an amine residue;
an alkyl group having from 1 to 4 carbon atoms; or
a phenyl group;
R⁵ is selected from:
a hydrogen atom;
a methyl group or a group —CO₂R⁷ wherein R⁷ is an alkyl group comprising from 1 to 4 carbon atoms;
and
R⁶ is selected from:
a hydrogen atom;
an alkyl group comprising 1 to 4 carbon atoms optionally substituted by a hydroxyl group; or
a group —CO₂R⁸ wherein R⁸ is selected from a hydrogen atom or an alkyl group comprising from 1 to 4 carbon atoms;
and m is an integer;
and optionally at least one unit of formula (II): 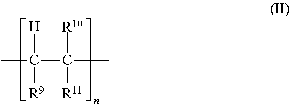
wherein:
R⁹ is selected from:
a hydrogen atom;
a methyl group; or
a group —CO₂R¹² wherein R¹² is selected from a hydrogen atom or an alkyl group comprising from 1 to 8 carbon atoms;
R¹⁰ is selected from:
a hydrogen atom;
an alkyl group comprising from 1 to 4 carbon atoms;
a hydroxymethyl group; or
a group —CO₂R¹³ wherein R¹³ is selected from a hydrogen atom or an alkyl group comprising from 1 to 8 carbon atoms;
R¹¹ is selected from:
a sulfonate containing group;
a residue —CO₂R¹⁴ wherein R¹⁴ is selected from a hydrogen atom or an alkyl group comprising from 1 to 4 carbon atoms;
a straight or branched alkyl residue having 1 to 8 carbon atoms optionally substituted by one to three carboxylic acid groups;
a phenyl residue;
an acetoxy residue;
hydroxymethyl;
an acetoxymethyl residue;
—SO₃M, —CH₂SO₃M, —PO₃M₂ or PO₃M′₂ in which M is selected from hydrogen, an alkali metal or an alkaline earth metal atom and M′ is M or C₁-C₄ alkyl; or
a residue —CONR¹⁵R¹⁶ wherein R¹⁵ and R¹⁶ are the same or different and each is selected from hydrogen, a straight or branched chain alkyl residue having 1 to 8 carbon atoms, hydroxymethyl or a residue —CH(OH)—CO₂M, —C(CH₃)₂CH₂SO₃M or —C(CH₃)₂CH₂PO₃M₂ in which M is selected from hydrogen, an alkali metal or alkaline earth metal atom; or
—N(R¹⁷)COCH₃ in which R¹⁷ is selected from hydrogen or C₁-C₄ straight or branched chain alkyl;
and n is an integer.

12. A method according to claim 9, wherein the method comprises treating a scrubber media comprising water and sodium hydroxide by addition of a combination of phosphino and/or phosphono polycarboxylic acids or salts thereof.

13. A method according to claim 9, wherein the method comprises treating a scrubber media by addition of a combination of a polymer P1 and polymer P2, wherein:
P1 has formula (III-P1): 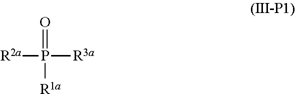
wherein:
R^{1a} is an —OX residue wherein X is selected from hydrogen or an alkali metal cation;
R^{2a} is a copolymer of acrylic acid and 2-acrylamido-2-methylpropane sulfonic acid (AMPS); and
R^{3a} is a copolymer of acrylic acid and 2-acrylamido-2-methylpropane sulfonic acid (AMPS) or
R^{3a} is an —OX residue wherein X is selected from hydrogen or an alkali metal cation; and
P2 has formula (III-P2): 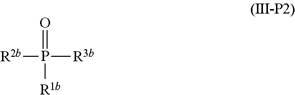
wherein
R^{1b} is an —OX residue wherein X is selected from hydrogen or an alkali metal cation;
R^{2b} is a homopolymer of acrylic acid or methacrylic acid; and
R^{3b} is a homopolymer of acrylic acid or methacrylic acid or R^{3b} is an —OX residue wherein X is selected from hydrogen or an alkali metal cation.

14. A method according to claim 9, wherein the method comprises treating an aqueous scrubber media comprising sodium hydroxide in an amount of at least 20% by weight by addition of a combination of (i) a phosphino homopolymer of acrylic acid and (ii) a phosphino copolymer of acrylic acid and 2-acrylamido-2-methylpropane sulfonic acid (AMPS) wherein the ratio of weight ratio of (i) to (ii) added to the scrubber media is from 1:2 to 2:1 and wherein said polymers are added in a combined amount of at least 100 ppm by weight.

15. A scrubber apparatus comprising a scrubber unit containing a scrubber media and wherein said scrubber media comprises a polycarboxylic acid composition.

16. An scrubber apparatus according to claim 15, wherein the scrubber media comprises an aqueous scrubber media comprising sodium hydroxide.

17. An scrubber apparatus according to claim 15, wherein the scrubber media comprises an aqueous media comprising sodium hydroxide in an amount of at least 20% by weight and a combination of (i) a phosphino homopolymer of acrylic acid and (ii) a phosphino copolymer of acrylic acid and 2-acrylamido-2-methylpropane sulfonic acid (AMPS) wherein the ratio of weight ratio of (i) to (ii) in the scrubber media is from 1:2 to 2:1 and wherein the scrubber media comprises said polymers in a combined amount of at least 100 ppm by weight.

18. A method of removing constituents from a gas stream, wherein the method comprises introducing a gas stream into a scrubber media and wherein said scrubber media comprises a polycarboxylic acid composition.

19. A method according to claim 18, wherein the scrubber media comprises an aqueous scrubber media comprising sodium hydroxide.

20. A method according to claim 18, wherein the scrubber media comprises an aqueous media comprising sodium hydroxide in an amount of at least 20% by weight and a combination of (i) a phosphino homopolymer of acrylic acid and (ii) a phosphino copolymer of acrylic acid and 2-acrylamido-2-methylpropane sulfonic acid (AMPS) wherein the ratio of weight ratio of (i) to (ii) in the scrubber media is from 1:2 to 2:1 and wherein the scrubber media comprises said polymers in a combined amount of at least 100 ppm by weight.

21. A polycarboxylic acid composition comprising a combination of two or more polycarboxylic acids for use to extend the operating life of a scrubber media.
